(19) United States
(12) Patent Application Publication
(10) Pub. No.: US 2018/0369844 A1
(43) Pub. Date: Dec. 27, 2018

(54) LIQUID CONTAINER

(71) Applicants: Sun Hong Kim, Anseong-si (KR); Jeong A. Choi, Seoul (KR)

(72) Inventors: Sun Hong Kim, Anseong-si (KR); Jeong A. Choi, Seoul (KR)

(21) Appl. No.: 16/013,972

(22) Filed: Jun. 21, 2018

(30) Foreign Application Priority Data
Jun. 24, 2017 (KR) 20-2017-0003267
Feb. 12, 2018 (KR) 20-2018-0000648

(51) Int. Cl. B05B 11/00; B05B 11/04

(52) U.S. Cl. CPC B05B 11/3043; B05B 11/0037; B05B 11/043; B05B 11/3038

(57) ABSTRACT

A liquid container comprises an upper part having an open bottom, a lower part having an open top, the lower part detachably coupled to the upper part under the upper part, and a cap detachably coupled to the lower part over or under the lower part, the cap having a flange formed along a lower outer circumference thereof, wherein a container opening/closing means coupling the upper part with the lower part, the container opening/closing means including a first opening/closing means or a second opening/closing means, wherein the first opening/closing means includes a bendable part attached to a lower side portion of the upper part and an upper side portion of the lower part, and wherein the second opening/closing means includes a hinge structure configured to open or close the upper part and the lower part with respect to each other.

### CROSS-REFERENCE TO RELATED APPLICATIONS

This patent application claims priority under 35 U.S.C. § 119 to Korean Utility Model Application No. 20-2017-0003267, filed on Jun. 24, 2017, and Korean Utility Model Application No. 20-2018-0000648, filed on Feb. 12, 2018, in the Korean Intellectual Property Office, the disclosures of which are incorporated by reference herein in their entireties.

### TECHNICAL FIELD

Embodiments of the disclosure relate to containers, and more specifically, liquid containers with a dispenser or pump.

### DISCUSSION OF RELATED ART

Pump- or dispenser-type liquid containers are widely in use to contain and comfortably consume shampoo, rinse, hair gel, or other various types of liquids or fluids.

A discharge hose extends from the pump and sucks up and discharges the content when the pump is pressed down.

Typically, the discharge pump, by its structure limitation, cannot fully discharge the content out of the container, causing a slight amount of content to be left on the bottom of the container. This may be the waste of the content.

To pull out the remaining content, the user may remove the pump from the container body and shake up and down the container with upside down. However, this way is uncomfortable and burdensome.

Alternatively, the user may cut away the head of the container—however, this is still annoying and may oftentimes be dangerous.

### SUMMARY

According to an embodiment, a liquid container comprises an upper part having an open bottom, a pump formed on the upper part, and a discharge hose extending downwards from the pump, a lower part having an open top, the lower part detachably coupled to the upper part under the upper part, and a cap detachably coupled to the lower part over or under the lower part, the cap having a flange formed along a lower outer circumference thereof, wherein a container opening/closing means coupling the upper part with the lower pan, the container opening/closing means including a first opening/closing means or a second opening/closing means, wherein the first opening/closing means includes a bendable part attached to a lower side portion of the upper part and an upper side portion of the lower part, and wherein the second opening/closing means includes a hinge structure configured to open or close the upper part and the lower part with respect to each other.

A finishing tape may be attached along where the upper part and the lower part meet each other. The finishing tape may be configured to be removed when the upper part is separated from the lower part.

A coupling piece may extend from a side lower portion of the upper part. The coupling piece may have a fastening protrusion. A separation piece may be depressed in a side upper portion of the lower part to allow the coupling piece to fit thereinto. The separation piece may have a fastening hole to which the fastening protrusion of the coupling piece is stuck.

The upper part may include a vertically elongate upper transparent window, and the lower part may include a vertically elongate lower transparent window. The upper transparent window and the lower transparent window each may have graduations marked thereon.

A connecting portion may be coupled to a lower portion of the lower part to form a space. A bottom connecting means may be provided to connect the connecting portion with the cap and to open or close the cap with respect to the connecting portion. The bottom connecting means may include a first connecting means forming a pair with the first opening/closing means or a second connecting means forming a pair with the second opening/closing means. The first connecting means may include a lower coupling protrusion configured to fit the cap over the cap. The lower coupling protrusion may extend downwards and be formed of an elastic synthetic resin to be received in the space by pressed up from thereunder. The second connecting means may include a hinge structure. The lower part may have an upper coupling protrusion in an upper portion thereof. The lower coupling protrusion may have the same diameter as the upper coupling protrusion.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIGS. 1 and 2 are perspective views illustrating a liquid container according to an embodiment;

FIGS. 3 and 4 are exploded perspective views illustrating a liquid container according to an embodiment;

FIGS. 5 and 6 are cross-sectional views illustrating a liquid container according to an embodiment;

FIG. 7 is a view illustrating a finishing tape of a liquid container according to an embodiment;

FIG. 8 is a view illustrating a cap coupler of a liquid container according to an embodiment;

FIG. 9 is a view illustrating an example of using a liquid container according to an embodiment;

FIG. 10 is a view illustrating an example of using a lower part of a liquid container according to an embodiment;

FIG. 11 is a view illustrating a liquid container, with the upper and lower parts of the liquid container separated from each other, according to an embodiment;

FIG. 12 is a view illustrating an example of using a lower part of a liquid container according to an embodiment;

FIG. 13 is a view illustrating an example of using a lower part of a liquid container according to an embodiment; and

FIG. 14 is a view illustrating an example of using a lower part of a liquid container according to an embodiment.

### DETAILED DESCRIPTION OF EXEMPLARY EMBODIMENTS

The disclosure may be understood through the embodiments to be described below taken in conjunction with the accompanying drawings.

However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

As used herein, the singular forms “a,” “an,” and “the” are intended to include the plural forms as well, unless the context clearly indicates otherwise.

Hereinafter, exemplary embodiments of the disclosure are described in detail with reference to the accompanying drawings. The same reference denotations may be used to refer to the same or similar elements throughout the specification and the drawings.

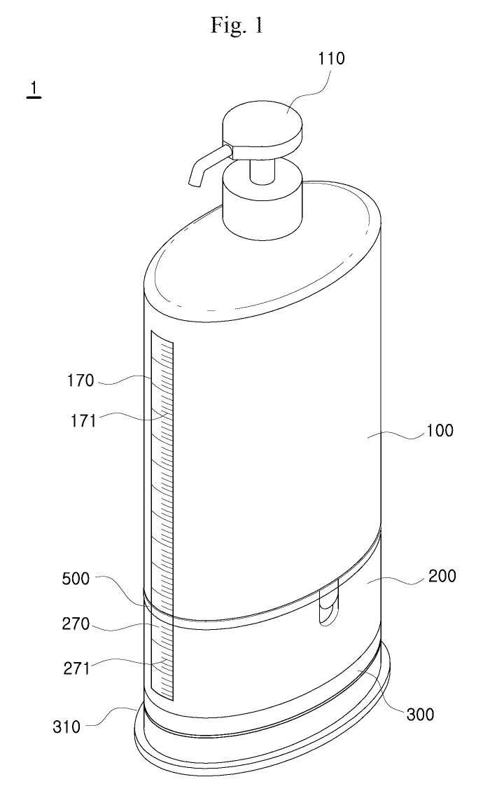

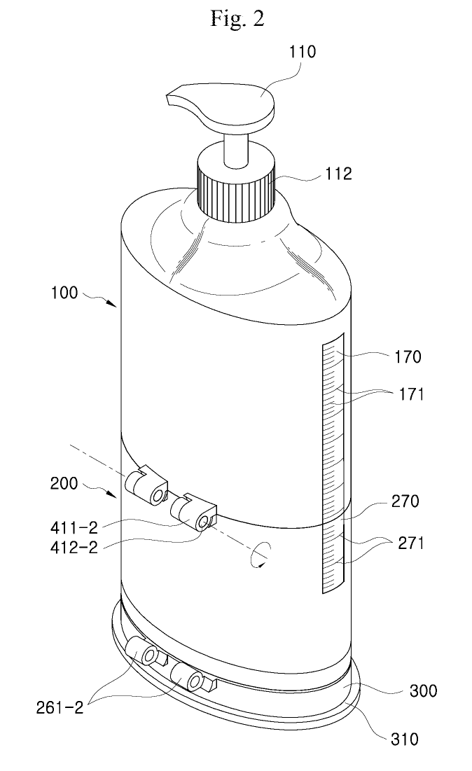

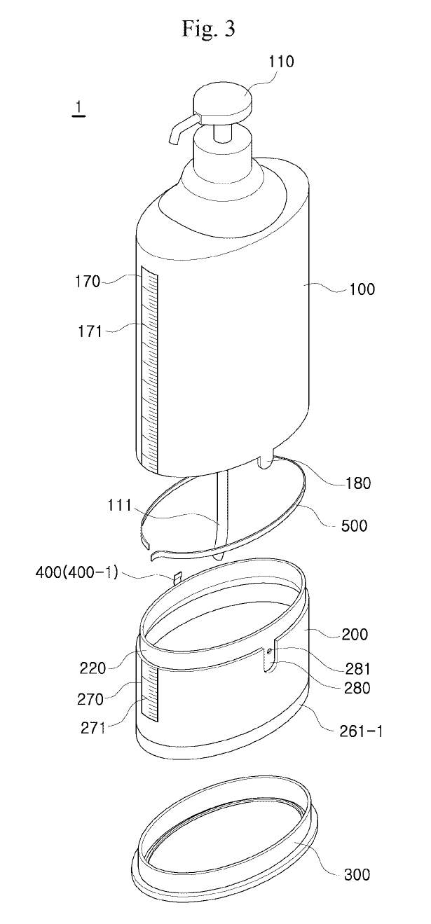

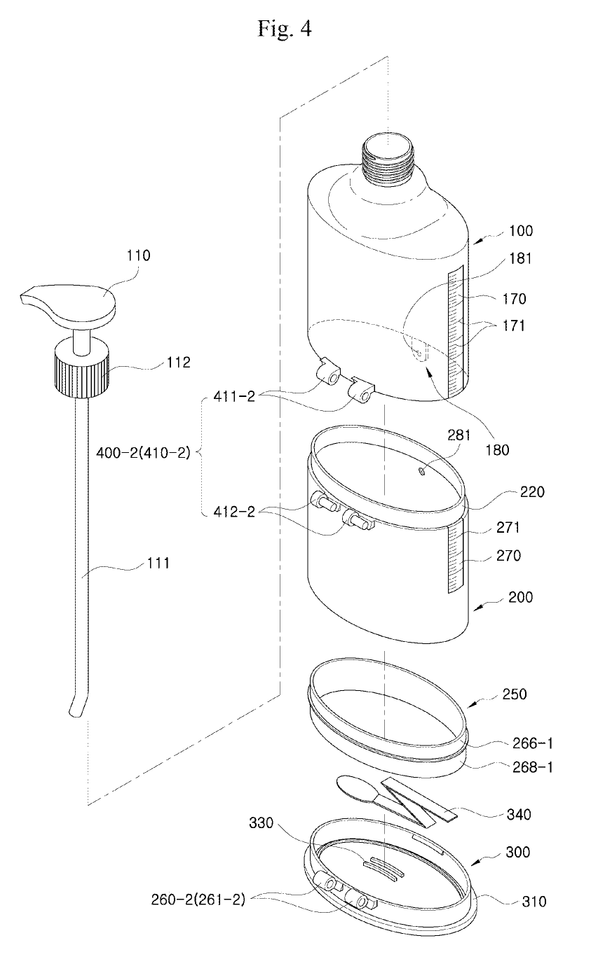

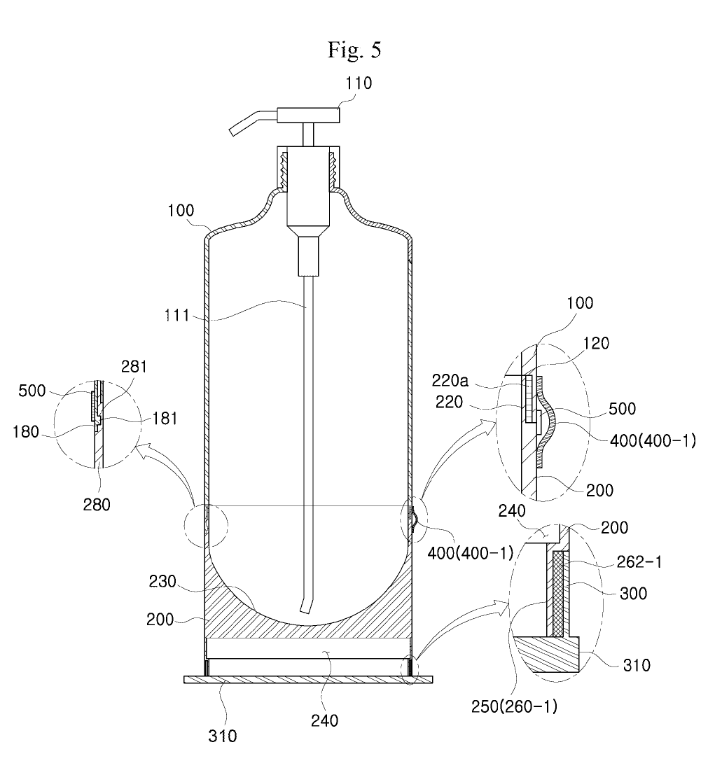

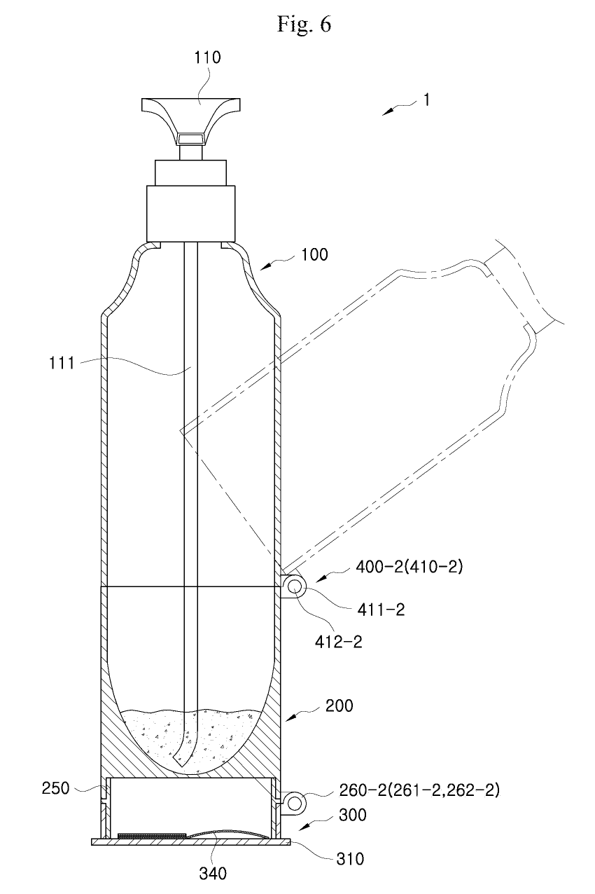

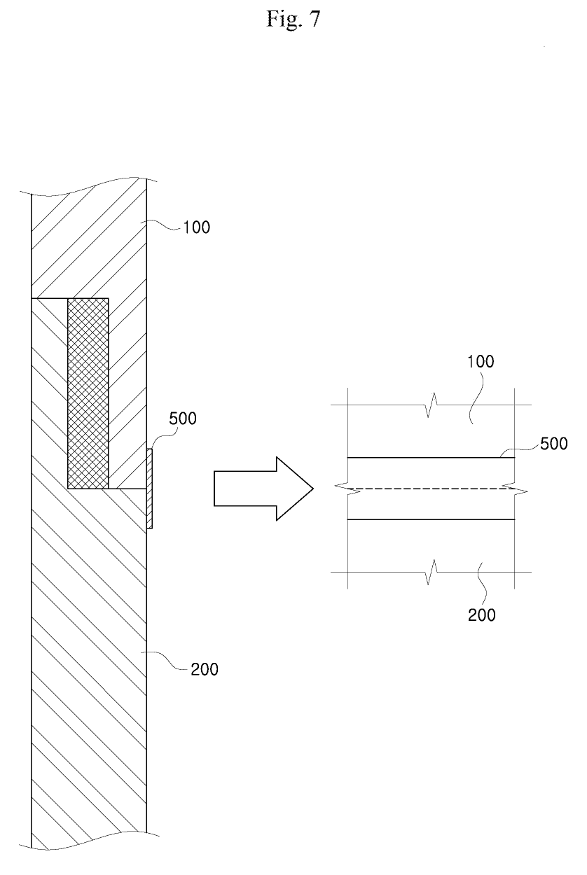

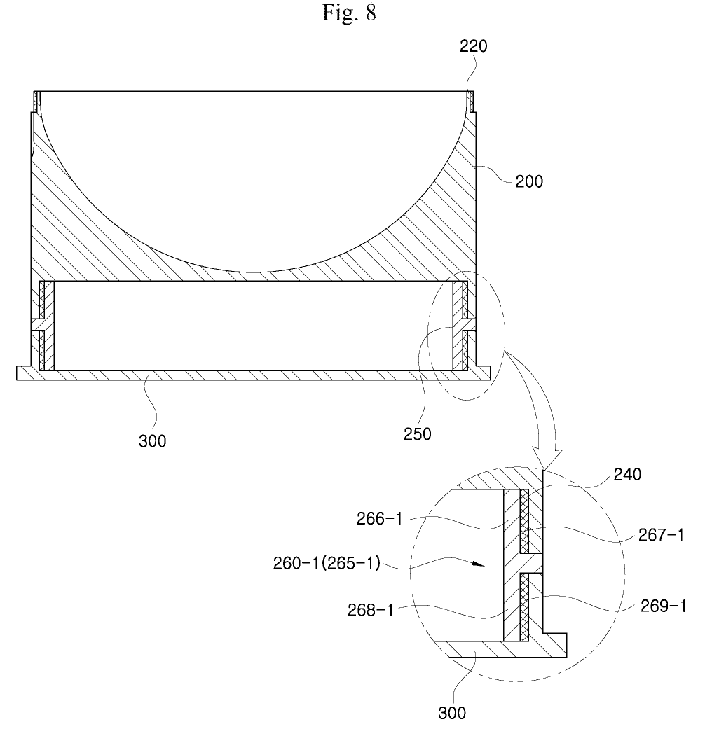

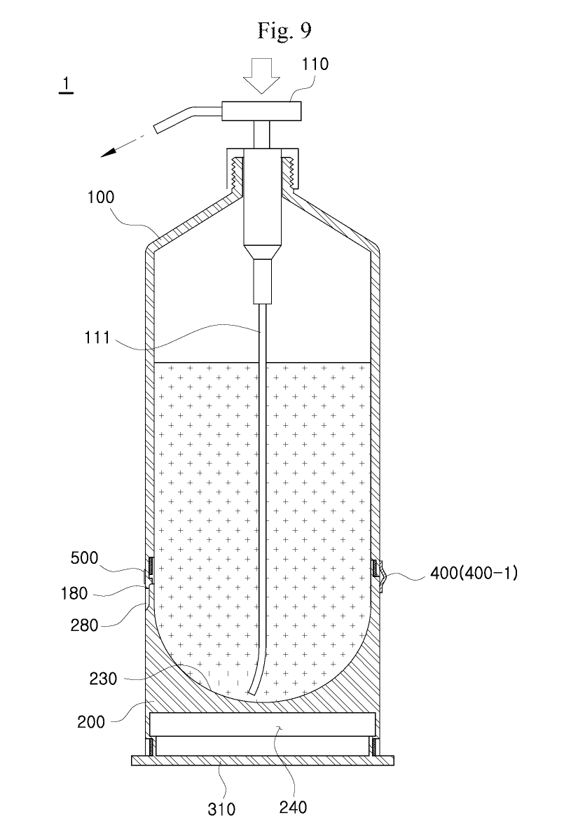

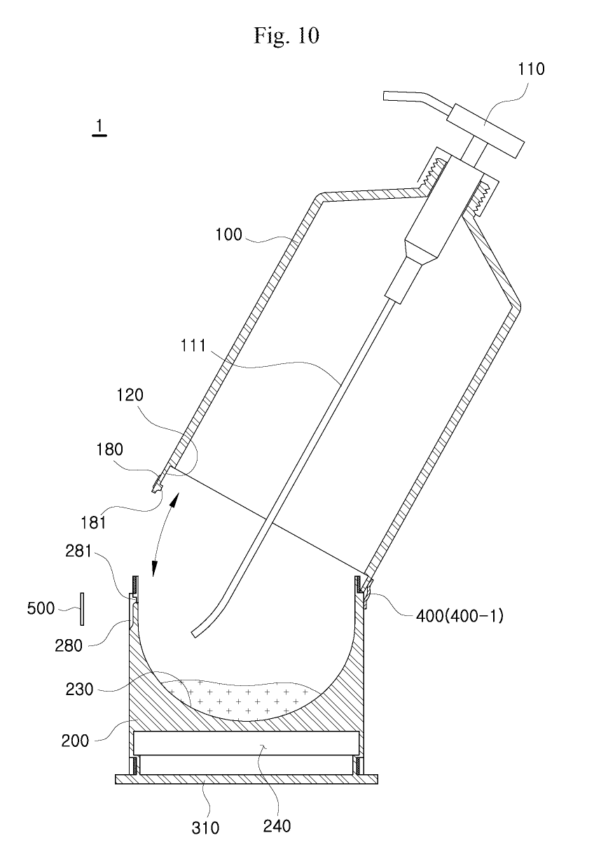

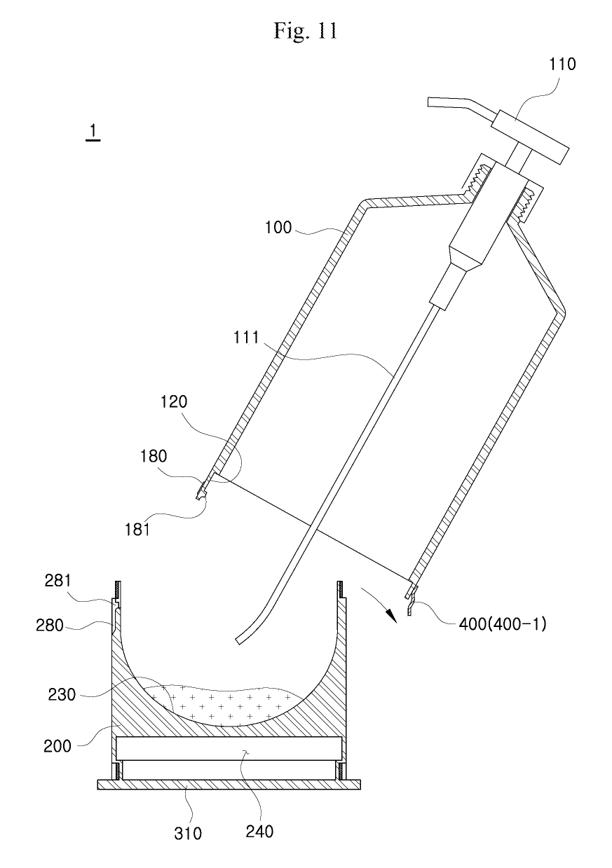

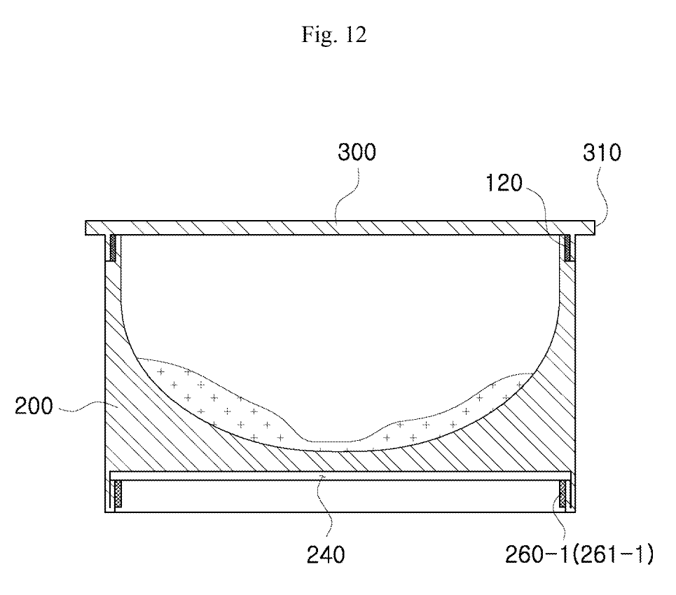

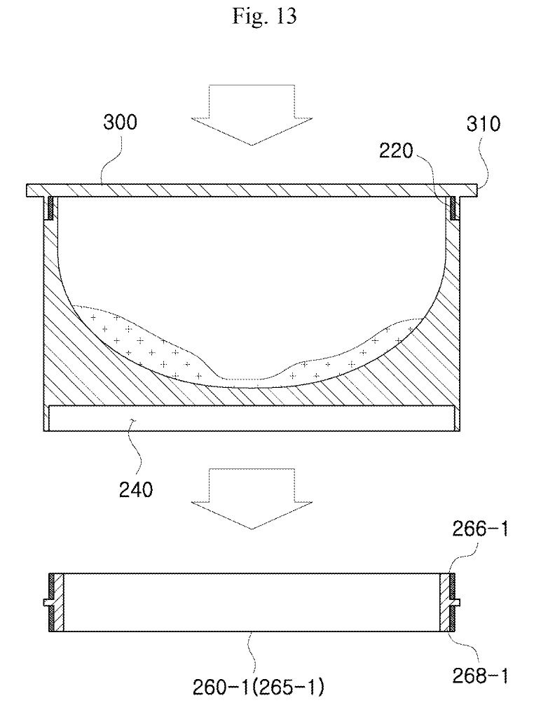

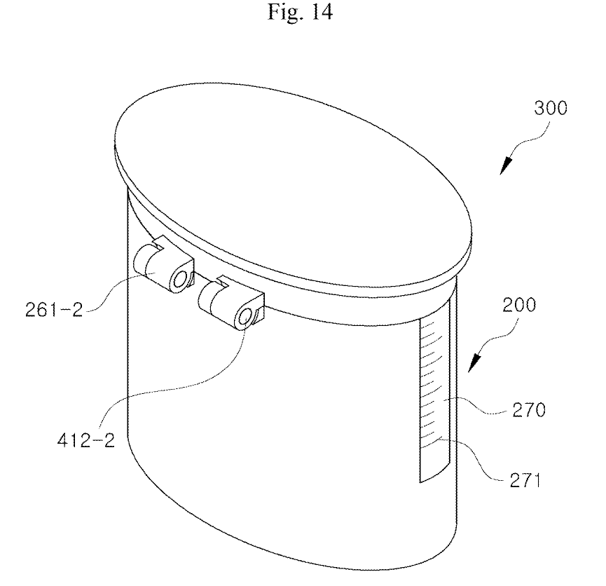

FIGS. 1 and 2 are perspective views illustrating a liquid container according to an embodiment. FIGS. 3 and 4 are exploded perspective views illustrating a liquid container according to an embodiment. FIGS. 5 and 6 are cross-sectional views illustrating a liquid container according to an embodiment. FIG. 7 is a view illustrating a finishing tape of a liquid container according to an embodiment. FIG. 8 is a view illustrating a cap coupler of a liquid container according to an embodiment. FIG. 9 is a view illustrating an example of using a liquid container according to an embodiment. FIG. 10 is a view illustrating an example of using a lower part of a liquid container according to an embodiment. FIG. 11 is a view illustrating a liquid container, with the upper and lower parts of the liquid container separated from each other, according to an embodiment. FIG. 12 is a view illustrating an example of using a lower part of a liquid container according to an embodiment. FIG. 13 is a view illustrating an example of using a lower part of a liquid container according to an embodiment. FIG. 14 is a view illustrating an example of using a lower part of a liquid container according to an embodiment.

Referring to FIGS. 1 to 6, a liquid container 1 includes an upper part 100, a lower part 200, and a cap 300.

The upper part 100 may configure an upper structure of the liquid container 1. The upper part 100 may be shaped substantially as an empty cylinder with an open bottom and may be formed of a synthetic material, e.g., plastic.

A pump 110 may be formed on the top of the upper part 100 to discharge the content from the liquid container 1. A discharge hose 111 extends from the pump 110 to the open bottom of the upper part 100.

The pump 110 may be integrally formed with the upper part 100 or the pump 110 may be screwed to the upper part 100, but embodiments of the disclosure are not limited thereto.

A coupling groove 120 is formed along the inner circumference of a lower portion of the upper part 100.

The lower part 200 may configure a lower structure of the liquid container 1. The lower part 200 may be shaped substantially as an empty cylinder with an open top and may be formed of a synthetic material, e.g., plastic. The lower part 200 may be shorter in height than the upper part 100.

The height of the lower part 200 is not limited to a particular one. For example, the height of the lower part 200 may range from 5 cm to 7 cm to allow the user to hold it in a comfortable way.

An upper coupling protrusion 220 may be formed along the outer circumference of an upper portion of the lower part 200. The upper coupling protrusion 220 may press-fit into the coupling groove 120 of the upper part 100.

An upper sealing member 220a may be wrapped around the upper coupling protrusion 220. The upper sealing member 220a may be formed of, e.g., rubber or silicone. The upper sealing member 220 may provide an air-tight sealing or more secure coupling between the lower part 200 and the upper part 100 when the lower part 200 and the upper part 100 fit together.

The lower part 200 has a semi-circular curved (concave) inner bottom 230 that is deepest at the center.

The lower part 200 is coupled to the upper part 100 via the upper coupling protrusion 220 and the coupling groove 120, forming, inside the liquid container 1 a space for receiving content, e.g., a liquid.

The upper part 100 and the lower part 200 may be coupled together via a container opening/closing means 400.

The container opening/closing means 400 may be configured of, or include, a first opening/closing means 400-1 or a second opening/closing means 400-2.

The first opening/closing means 400-1 may be, or include, a soft, bendable part 400-1 formed of a synthetic material. An upper portion of the first opening/closing means 400-1 is attached or fused to a side lower end of the upper part 100, and a lower portion of the first opening/closing means 400-1 is fused to a side upper end of the lower part 200. The first opening/closing means 400-1 may be bent when the upper part 100 is partially separated from the lower part 200 and may be detached or disconnected when the upper part 100 is fully separated from the lower part 200.

The second opening/closing means 400-2 includes a hinge structure 410-2. The hinge structure 410-2 includes sleeves 411-2 and pins 412-2. The sleeves 411-2 may be provided on a lower end of the upper part 100, and the pins 412-2 may be formed on an upper end of the lower part 200. The pins 412-2 may rotatably fit into the sleeves 411-2.

According to an embodiment, a pair of sleeves 411-2 and a pair of pins 412-2 may be formed.

A film-type finishing tape 500 may be attached along and to the lower outer circumference of the upper part 100 and the upper outer circumference of the lower part 200 as shown in FIG. 7.

The finishing tape 500 is configured to stably hold the upper part 100 and the lower part 200 not to be separated from each other when the liquid container 1 is in normal use and to be removed by the user when the upper part 100 and the lower part 200 are separated from each other.

The cap 300 may have a top opening and be detachably coupled to the outer bottom of the lower part 200. When the upper part 100 and the lower part 200 are separately used, the cap 300 may be used to open or cover the top opening of the lower part 200. The cap 300 may be formed of, e.g., a synthetic material.

A flange 310 may stick out from the lower outer circumference of the cap 300, allowing the liquid container 1 to stand in a stable position while facilitating to grab the cap 300 when the cap 300 is separated from the lower part 200.

A space 240 may be formed in a lower portion of the lower part 200 under the inner curved bottom 230.

A connecting portion 250 may be formed in the lower portion of the lower part 200 to detachably couple the cap 300 to the lower part 200.

The connecting portion 250 includes a bottom connecting means 260 to couple the connecting portion 250 with the cap 300, thereby opening or closing the cap 300.

The bottom connecting means 260 includes a first connecting means 260-1 or a second connecting means 260-2.

According to an embodiment, the first connecting means 260-1 may be a lower coupling protrusion 261-1 that protrudes from the lower end of the lower part 200 downwards and has the same diameter as the upper coupling protrusion 220 as shown in FIGS. 1 to 6. A sealing member 262-1 is formed of, e.g., rubber or silicone, along the circumference of the lower coupling protrusion 261-1 to be press-fittable.

The lower coupling protrusion 261-1 may be formed of an elastic, or bendable, synthetic material. The lower coupling protrusion 261-1, when pressed from thereunder, may elastically enter the inside of the space 240 and may thus be hidden from the outside.

In other words, the cap 300 may be configured to be press-fittable into the lower coupling protrusion 261-1 of the lower part 200, and as necessary, may be separated from the lower coupling protrusion 261-1 and instead coupled to the upper coupling protrusion 220 of the lower part 200.

Referring to FIG. 5, the connecting portion 250 may be formed of a first coupling member 265-1 for coupling the lower part 200 with the cap 300.

The first coupling member 265-1 includes a first coupling protrusion 266-1, which is an upper portion of the first coupling member 265-1 and is configured to be press-fittable into the space 240. A first sealing member 267-1 formed of rubber or silicone may be wrapped around the circumference of the first coupling protrusion 266-1. The first sealing member 267-1 may be press-fitted into the space 240, allowing for air-tight sealing.

The first coupling member 265-1 includes a second coupling protrusion 268-1, which is a lower portion of the first coupling member 265-1 and is configured to be press-fittable into the cap 300. The second coupling protrusion 268-1 has the same diameter as the upper coupling protrusion 220 of the lower part 200 or the same diameter as the first coupling protrusion 266-1. A second sealing member 269-1 formed of rubber or silicone may be wrapped around the circumference of the second coupling protrusion 268-1. The second sealing member 269-1 may be press-fitted into the cap 300, allowing for air-tight sealing.

In other words, the first coupling member 265-1 may be fitted into the space 240 via the upper, first coupling protrusion 266-1 and into the cap 300 via the lower, second coupling protrusion 268-1.

The second connecting means 260-2 includes a hinge structure 261-2 that allows the connecting portion 250 and the cap 300 to pivot about each other, and the hinge structure 261-2 includes sleeves 262-2 and pins 263-2.

The sleeves 262-2 may be rotatably coupled with the pins 412-2 formed in an upper end of the lower part 200 as shown in FIG. 14. The pins 263-2 may be omitted when not required.

A spoon 340 may be placed via the space 240 in the cap 300. The handle of the spoon 340 may be folded. The spoon 340 may be a paper spoon. Spoon fixing protrusions 330 may be formed in the cap 300 to save the spoon 340. The spoon 340 may be stuck between the spoon fixing protrusions 330, thus prevented from moving.

The connecting portion 250 may reinforce the hardness or stiffness of the lower part 200, e.g., when the lower part 200 is thin. The connecting portion 250 may be omitted according to an embodiment.

The upper part 100 and the lower part 200, respectively, may have an upper transparent window 170 and a lower transparent window 270, which are elongate along the vertical direction, allowing the user to check how much the content remains in the liquid container 1. The upper transparent window 170 and the lower transparent window 270 may be configured to be continuous to each other when the upper part 100 and the lower part 200 are in the position of being coupled together.

The upper and lower transparent windows 170 and 270 may have upper graduations 171 and lower graduations 271, respectively.

The upper part 100 may have a coupling piece 180 extending from the bottom. The coupling piece 180 may have a coupling protrusion 181 formed on an inner surface thereof. The lower part 200 may have a separation piece 280 depressed in a top side portion thereof to allow the coupling piece 180 to be fitted thereinto. The separation piece 280 may have a fastening hole 281 to which the coupling protrusion 181 is stuck. As the coupling protrusion 181 of the coupling piece 180 fits into the fastening hole 281 of the separation piece 280, the upper part 100 and the lower part 200 may firmly be fastened together.

The coupling protrusion 181 may be fastened to the fastening hole 281 in such an extent that the upper part 100 can be escaped off when the user pushes the upper part 100 aside.

The separation piece 280 may be longer than the coupling piece 180 to allow the user to easily separate the upper part 100 from the lower part 200 by putting his finger in the space between the coupling piece 180 and the separation piece 280 and hooking up the separation piece 180.

Examples of using the liquid container 1 are described below with reference to the accompanying drawings.

According to an embodiment, the liquid container 1 may be prepared with the upper part 100 and the lower part 200 assembled together, as default. A content may be contained inside the upper part 100 and the lower part 200.

As the user presses the pump 110 on the upper part 100, the pump 110 may suck up and discharge out the content via the discharge hose 111.

The user may realize how much the content remains in the liquid container 1 through the upper and lower transparent windows 170 and 270 formed in the upper and lower parts 100 and 200. In this case, the graduations marked on the upper and lower transparent windows 170 and 270 may give the user more accurate checks on the amount of the remaining content.

This allows the user to make up before the content is used up, preventing any inconvenience due to the exhaustion of the content and getting it ready to use all the time.

According to an embodiment, the concave inner bottom of the lower part 200, by its unique shape, allows the content to be collected in the central bottom, enabling the content to be used without waste.

Although such a very tiny amount of content as is unable to be sucked up by the pump 110 is left inside the liquid container 1, the user may open the lower part 200 by separating the upper part 100 from the lower part 200 and fully use the remaining content.

For example, the user may remove the finishing tape 500 before separating the upper part 100 and the lower part 200 from each other.

The user may put his finger in the separation piece 280 of the lower part 200 and hook up the coupling piece 180 of the upper part 100 while turning away the upper part 100 on the bendable part 400-1, as the axis. Then, the coupling protrusion 181 of the coupling piece 180 may be released from the fastening hole 281, so that the upper part 100 and the lower part 200 may be separated from each other.

Thus, the top of the lower part 200 may be open. The user may pull out the content from the lower part 200 via the open top, thus able to use up the content without waste. After use, the upper part 100 may be coupled back to the lower part 200.

According to an embodiment, when a tiny amount of content remains in the liquid container 1, and the user desires to consume the remaining content, the user may separate the upper part 100 from the lower part 200 as shown in FIG. 11.

Specifically, as an example, the user may remove the bendable part 400-1 by forcedly pulling down the bendable part 400-1 attached to the lower part 200, thereby separating the upper part 100 from the lower part 200. The user may close the open top of the lower part 200 with the cap 300, preventing the content from going bad or clotting due to the influx of air, dust, or other foreign bodies into the inside the lower part 200.

For example, where the connecting portion 250 is formed of the lower coupling protrusion 261-1 as shown in FIGS. 1 to 6 and 12, the user may remove the cap 300 from the lower coupling protrusion 261-1 by pulling down the cap 300.

The user may close the open top of the lower part 200 by fitting the cap 300 over the upper coupling protrusion 220 of the lower part 200.

When the cap 300 is released out of the outer bottom of the lower part 200, the lower coupling protrusion 261-1 which is exposed outside may spoil the appearance.

However, since the lower coupling protrusion 261-1 is elastic and bendable, the user may position the lower coupling protrusion 261-1 inside the space 240 of the lower part 200 by pushing up the lower coupling protrusion 261-1, allowing the lower coupling protrusion 261-1 to be hidden from the outside.

For example, where the connecting portion 250 is formed of the first coupling member 265-1 as shown in FIGS. 8 and 13, the user may remove the cap 300 from the second coupling protrusion 268-1 by pulling down the cap 300.

The user may close the open top of the lower pan 200 by fitting the cap 300 over the upper coupling protrusion 220 of the lower part 200.

When the cap 300 is released out of the connecting portion 250, the first connecting means 260-1 which is exposed outside may spoil the appearance.

The first coupling member 265-1 may be removed from the lower part 200 by unfitting the first coupling protrusion 266-1 of the first connecting means 260-1 from the space 240.

As such, the user may easily couple or decouple the cap 300 to/from the lower part 200, allowing the content to be fully used without waste, or when remaining, to be protected against, e.g., the air or dust.

As set forth above, the connecting portion 250 may be hidden or removed as necessary, allowing the liquid container 1 to remain in an aesthetic look while protecting the lower part 200.

It will be appreciated by one of ordinary skill in the art that the disclosure may be implemented in other various specific forms without changing the essence or technical spirit of the disclosure. Thus, it should be noted that the above-described embodiments are provided as examples and should not be interpreted as limiting. It should be noted that the scope of the disclosure is defined by the appended claims rather than the described description of the embodiments and include all modifications or changes made to the claims or equivalents of the claims.

What is claimed is:

1. A liquid container, comprising:
an upper part having an open bottom, a pump formed on the upper part, and a discharge hose extending downwards from the pump;
a lower part having an open top, the lower part detachably coupled to the upper part under the upper part; and
a cap detachably coupled to the lower part over or under the lower part, the cap having a flange formed along a lower outer circumference thereof, wherein a container opening/closing means coupling the upper part with the lower part, the container opening/closing means including a first opening/closing means or a second opening/closing means, wherein the first opening/closing means includes a bendable part attached to a lower side portion of the upper part and an upper side portion of the lower part, and wherein the second opening/closing means includes a hinge structure configured to open or close the upper part and the lower part with respect to each other.

2. The liquid container of claim 1, wherein a finishing tape is attached along where the upper part and the lower part meet each other, and wherein the finishing tape is configured to be removed when the upper part is separated from the lower part.

3. The liquid container of claim 1, wherein a coupling piece extends from a side lower portion of the upper part, the coupling piece having a fastening protrusion, and wherein a separation piece depressed in a side upper portion of the lower part to allow the coupling piece to fit thereinto, the separation piece having a fastening hole to which the fastening protrusion of the coupling piece is stuck.

4. The liquid container of claim 1, wherein the upper part includes a vertically elongate upper transparent window, and the lower part includes a vertically elongate lower transparent window, and wherein the upper transparent window and the lower transparent window each have graduations marked thereon.

5. The liquid container of claim 1, wherein a connecting portion is coupled to a lower portion of the lower part to form a space, wherein a bottom connecting means is provided to connect the connecting portion with the cap and to open or close the cap with respect to the connecting portion, the bottom connecting means including a first connecting means forming a pair with the first opening/closing means or a second connecting means forming a pair with the second opening/closing means, wherein the first connecting means includes a lower coupling protrusion configured to fit the cap over the cap, the lower coupling protrusion extending downwards and formed of an elastic synthetic resin to be received in the space by pressed up from thereunder, wherein the second connecting means includes a hinge structure, and wherein the lower part has an upper coupling protrusion in an upper portion thereof, and the lower coupling protrusion has the same diameter as the upper coupling protrusion.
